(19) United States
(12) Patent Application Publication
(10) Pub. No.: US 2008/0146150 A1
(43) Pub. Date: Jun. 19, 2008

(54) WiFi SiP module

(75) Inventors: Wen-Bing Luo, Taipei City (TW); Yu-Hsuan Wu, Kaohsiung City (TW); Ting-Yi Tsai, Taipei City (TW); I-Ru Liu, Taipei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/640,296

(22) Filed: Dec. 18, 2006

(51) Int. Cl. H04B 7/00

(52) U.S. Cl. 455/41.2; 370/310

(57) ABSTRACT

The present invention provides a WiFi SiP module comprising BB/MAC/RF processing unit integrating base band processor, MAC and radio frequency back end, wherein the base band processor supports IEEE 802.11a/g data rates. The MAC supports IEEE 802.11 wireless MAC protocol and IEEE 802.11 wireless security. The BB/MAC/RF processing unit includes a local-bus port for coupling to a local-bus.

### BACKGROUND OF THE INVENTION

1. Field of the Invention

The invention relates to a wireless communication module, and more specifically, to a WiFi SiP module for a portable communication device.

2. Description of the Prior Art

With the rise of chip and communication technology, many devices are getting smaller with higher capabilities. The global system for mobile communication (GSM) is a mobile phone system used widely overseas, except Japan, such as in Europe, Asia and North America. A feature of this system is to separate a mobile phone terminal and an operator by using a subscriber identity module (SIM) card. In this system, when a user purchases a mobile phone, the user selects a mobile phone and then selects an arbitrary service company as the operator to be used. The advance of mobile technology allows increased portability of various devices. In recent years, mobile phones have acquired more and more functions, and a great amount of information needs to be input into the mobile phones to utilize most of these functions. The functions of the cellular phone also have been increasing, with some services now supporting Internet access through the cellular phone.

The need for personal wireless communications is expanding rapidly with the advances in digital communications and personal communications systems. Retail stores and warehouses, for example, may use wireless communications systems with mobile data terminals to track. The transportation industry may use such systems at large outdoor storage facilities to keep an accurate account of incoming and outgoing shipments. Many of the current wireless networks architectures are primarily designed for personal and portable computers. The use of wireless communication systems to transmit data traffic utilizing mobile devices which communicate with a hardwired network, such as a LAN or a wide area network (WAN), has become developed. A mobile worker can be connected everywhere on an office building or business campus, which translates into increased productivity. Since the characteristics and profile of voice traffic are very different from those of data traffic, the wireless access protocol must efficiently accommodate the very dynamic of voice traffic. A typical wireless communications system includes a number of fixed access points (also known as base stations) interconnected by a cable medium to construct a local network.

FIG. 1 illustrates the functional diagram according to the prior art. The prior art includes a BB/MAC processing unit 100 to process and control the transmitting or receiving signal. A RF (radio frequency) processing unit 102 is coupled to the BB/MAC processing unit 100 to deal with the RF signals for RF communications. A transmitting/receiving switcher (T/R SW) 118 is respectively coupled to the BB/MAC processing unit 100 and the RF (radio frequency) processing 102, the BB/MAC processing unit 100 control the T/R SW 116 via the transmitting/receiving selecting port (TX/RX select) of the BB/MAC processing unit 100 to determine to receive from the antenna, and transmit the signal from the RF processing unit 102. A filter 118 is, for instance 801.11b/g filter, connected between the T/R SW 118 and the WiFi/Bluetooth power divider or switch (WiFi/BT PD or SW) 110. The WiFi/BT PD or SW 110 is used to let the TX/RX signals of WiFi and BT can pass concurrently, or decide which TX/RX signals of either WiFi or BT only have the permission to pass. Therefore, a blue tooth (BT) module 108 is connected to the WiFi module via the (WiFi/BT PD or SW) 110. As known in the art, GPIO (general purpose input/output), JTAG, initialization configuration, CF, SDIO/SPI are respectively coupled to the corresponding ports of the BB/MAC processing unit 100 to perform their pre-determined functions. It is appreciated that one person skilled in the art will recognize the functions and redundant illustration will be omitted. An oscillator 104 and memory 106 are coupled to BB/MAC processing unit 100, as well known in the art.

The prior art SiP module frequently use SDIO/SPI as IO interfaces, and the serial IO buses is around 4-bit/1-bit. The number of data and control lines is few, and port number is usually limited (one) in current embedded systems, therefore, the data-rate is limited by bit number and may be influenced by IO processing speed. The data-rate is very much dependent on the performance of driver and the OS under which the driver runs, based on current technology. Alternatively, the SiP module optionally use PC card/CF as IO interface that is parallel IO buses and it is around 16-bit. The number of data, address and control lines is more than last example. However, the port number is usually non-available (none or one) in current embedded systems. The data-rate may be influenced by IO processing speed and the data-rate is probably dependent on the performance of driver and the OS under which the driver runs. Further, the size of the prior art is huge if the package scheme is SIP (system in package), therefore, it is unlikely to be introduced into the portable device such as mobile phone. Further, the local bus for data communication is not available. The system of FIG. 1 is adapted to one antenna scheme only.

In view of the aforementioned, what is required is to provide a novel system with SiP scheme which may be operated in lieu of local bus.

### SUMMARY OF THE INVENTION

The main object of the present invention is to disclose a WiFi SiP module for mobile device.

One aspect of the present invention is that the BB/MAC/RF processing unit includes a local-bus port to allow a local-bus to couple to the BB/MAC/RF processing unit via the local-bus port, thereby providing high speed operation. The local-bus in client side is connected toward client CPU along AHB lines with the help of only memory buffer and without the helps of any Bridge and/or IO interface, which indeed lower the processing speed in most cases.

The further benefit of the local-bus is high throughputs, it's about four fold/fourteen fold relative to the ones of SDIO/SPI. The other benefit of the local-bus is the possibility to be connected to the Host IO buses of PC Card/CF (PCMCIA/CF of PXA270 with port number of 2 and the two ports are eliminated to one or none in reality. The local-bus is the possibility to be connected to Host memory bus and directly connected toward CPU.

The present invention provides a WiFi SiP module comprising BB/MAC/RF processing unit integrating base band processor, MAC and radio frequency back end, wherein the base band processor supports IEEE 802.11a/g data rates. The MAC supports IEEE 802.11 wireless MAC protocol and IEEE 802.11 wireless security. The BB/MAC/RF processing unit includes a local-bus port for coupling to a local-bus.

A RF front end is coupled to the BB/MAC/RF processing unit via transmitting and receiving ports to transfer transmitting and receiving signal. A first oscillator is coupled to the BB/MAC/RF processing unit, wherein the first oscillator is capable to generate a first oscillation frequency, wherein the first oscillation frequency is about 40 MHz. A second oscillator is also coupled to the BB/MAC/RF processing unit for generating a second oscillation frequency with 32 KHz.

The BB/MAC/RF processing unit includes a transmitting/receiving mode selection port that is coupled to the RF front end to allow the BB/MAC/RF processing unit to determine a processing mode. A memory is coupled to the BB/MAC/RF processing unit, wherein the memory includes non-volatile memory. The RF front end module includes a first and a second antenna port to couple to a first and a second antenna. Thus, the BB/MAC/RF processing unit includes an antenna diversity selection port that is coupled to the RF front end to allow the BB/MAC/RF processing unit to select an antenna diversity mode. The BB/MAC/RF processing unit further includes a blue tooth port for coupling to a blue tooth module.

### BRIEF DESCRIPTION OF THE DRAWINGS

For a better understanding of the present invention and to show how it may be carried into effect, reference will now be made to the following drawings, which show the preferred embodiments of the present invention, in which:

FIG. 1 shows a SiP mode according to prior art.

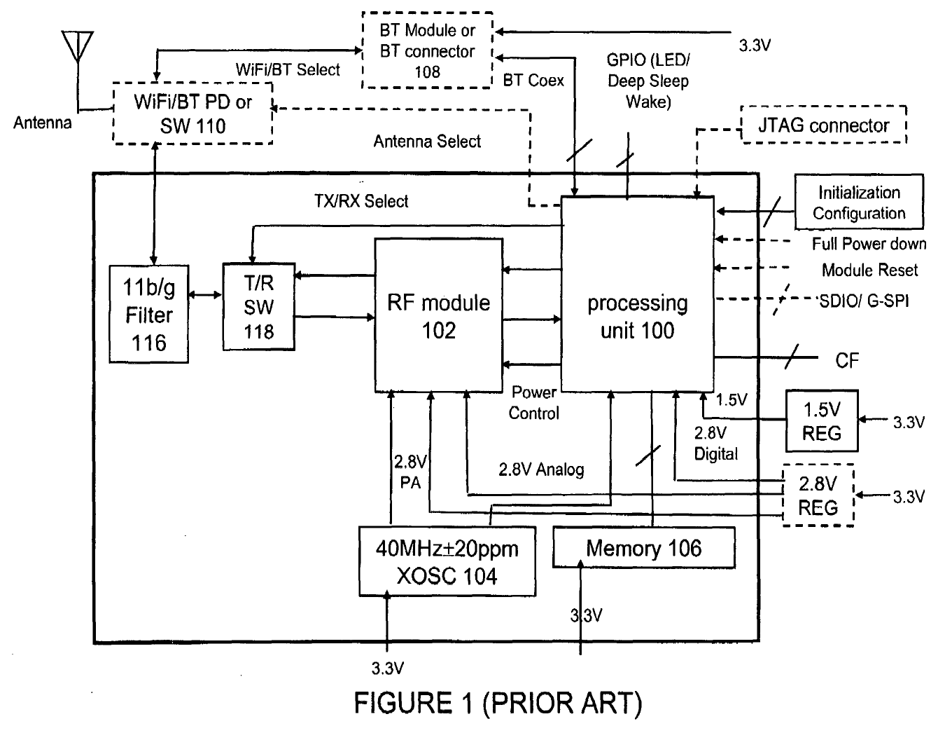

FIG. 2 shows a SiP mode according to the present invention.

### DESCRIPTION OF THE PREFERRED EMBODIMENTS

The present invention discloses a novel WiFi SiP (System in Package) module for portable communication device. In the following description, numerous specific details are set forth in order to provide a thorough understanding of the present invention, and the scope of the present invention is expressly not limited expect as specified in the accompanying claims. One skilled in the relevant art will recognize, however that the invention may be practiced without one or more of the specific details. In other instances, well known structures, materials, or operations are not shown or described in order to avoid obscuring aspects of the invention.

Those of ordinary skill in the art will immediately realize that the embodiments of the present invention described herein in the context of methods and schematics are illustrative only and are not intended to be in any way limiting. Other embodiments of the present invention will readily suggest themselves to such skilled persons having the benefits of this disclosure.

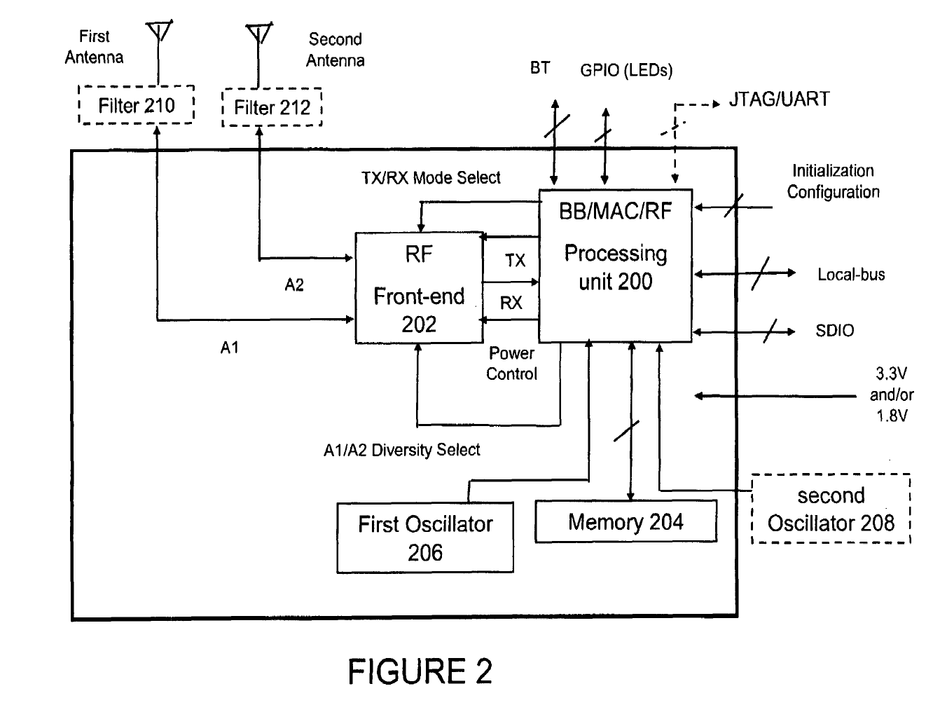

Turning to FIG. 2, the present invention requires a BB (base band)/MAC/RF (radio frequency) processing unit 200 that at least combines 3 performance and function. The BB/MAC/RF processing unit 200 is, for instance CMOS, single chip for combined cellular/handset applications. It may, for example, includes 2.4/5 GHz radio, analog-to-digital converters, a baseband processor, multi-media protocol media access control (MAC), and a CPU. The processing unit 200 enables a high performance, cost effective, low power, compact solution in dual mode cellular/WLAN portable device including, but not limited to PDA, VoIP, MP 3, MP 4 and mobile phone. The transmitter of the BB/MAC/RF processing unit 200 combined baseband in phase and quadrature signals, converts the signal to desired frequency. The receiver of the BB/MAC/RF processing unit 200 uses dual conversion architecture and requires no off-chip intermediate frequency filters. The frequency synthesizer supports the frequency defined by the 802.11 specification. Preferably, the BB/MAC/RF processing unit 200 supports the OFDM and the MAC supports IEEE 802.11 wireless MAC protocol as well as 802.11i security. The BB/MAC/RF processing unit 200 provides multiple user interfaces including, but not limited to JTAG/UART, SDIO, SPI, initialization configuration, other internal interfaces including memory, GPIO and LED. In addition to 4-bit SDIO and 1-bit SPI, the preference provides the interface of 16-bit local-bus, at the expense of 1) increasing routing trace number, 2) increasing pad (or ball) count, and resulting in 3) increasing occupied room for trace and pad (or ball) layout.

A RF front end 202 is coupled to the BB/MAC/RF processing unit 200 to further process the receiving or transmitting signals which are under receiving or transmitting. The process of RF front end 202 includes Low Noise Amplifying, Power Amplifying, Filtering, and/or Switching. Please be noted, the BB/MAC/RF processing unit 200 includes a TX/RX mode selection port coupling to the first port of the RF front end 202 to allow the BB/MAC/RF processing unit 200 to control the RF front end 202 to process the transmitting signal or receiving signal. A transmitting port, a receiving port and a power control port of the BB/MAC/RF processing unit 200 are respectively coupled to the second, third and forth ports of the RF front end 202 to allow the BB/MAC/RF processing unit 200 to receive signal from or transmit signal to the RF front end 202.

A first antenna and a second antenna are coupled to the fifth and sixth ports of the RF front end 202 through the corresponding filter 208 and 210, respectively. It provides two routs to transmit/receive signal to or from one of the dual antenna. Preferably, the first antenna and the second antenna may be in a diversity configuration. Therefore, an antenna diversity selection port of the BB/MAC/RF processing unit 200 is coupled to the seventh ports of the RF front end 202.

A first oscillator 206 is provided and coupled to the BB/MAC/RF processing unit 200, thereby providing a first operation frequency to the present WiFi SiP module. In one example, the frequency of the first oscillator 206 is about 40 MHz. A second oscillator 208 is employed and coupled to the BB/MAC/RF processing unit 200 as well to offer a second operation frequency to the present module. In normal operation mode, the WiFi SiP module is operated under 40 MHz. The WiFi SiP module is processed under 32 KHz during power-saving mode. A memory 204, such as FLASH, is coupled to the BB/MAC/RF processing unit 200 to store the non-volatile digital data. A blue tooth (BT) port is also provided to the BB/MAC/RF processing unit 200 to allow the BT coexistence function. Those of ordinary skill in the art will immediately realize that the examples described herein are illustrative only and are not intended to be in any way limiting.

One aspect of the present invention is that a local-bus is coupled to the BB/MAC/RF processing unit 200 via the local-bus port, thereby providing high speed operation. The local-bus in client side is connected toward Client CPU along AHB lines with the help of only memory buffer and without the helps of any Bridge and/or IO interface, which indeed lower the processing speed in most cases.

The first benefit of the local-bus is high throughputs, it's about four fold/fourteen fold relative to the ones of SDIO/SPI. The second benefit of the local-bus is the possibility to be connected to the host memory buses of PC Card/CF (PCMCIA/CF of PXA270 with socket number of 2 and the two sockets are eliminated to one or none in reality. The third benefit of the local-bus is the possibility to be connected to host static memory buses (ROM, Flash, SRAM, SRAM-like Variable Latency I/O or VLIO of PXA270 with bank number of 6 and usually most of the banks are available to be utilized). The fourth benefit of the local-bus is the possibility to be directly connected toward CPU, that is, to Host local-bus (System bus of PXA270 for example, then the throughput can be theoretically tuned, between the CPUs of host and client, to the greatest number of all)

The present invention has form factor less or much less than 200 mm̂2 in area, and less or much less than 2.0 mm in height with the thicknesses of the soldering pads (or balls) and the shield structure (or molding material). The present invention also uses PCB as substrate which usually has 6 or 4-layer stack-up structure, or even more layers, for example, of 10 or 12, if uses LTCC as substrate. The top-side copper of the substrate is used to be mounted by the components of SMDs, Flip Chip Packaged Devices or other Devices with Chip Scaled Package and the components can be optionally mounted on the bottom-side copper or on some inner-side copper.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A WiFi SiP module, comprising:
a BB/MAC/RF processing unit integrating base band processor, MAC and radio frequency back end and including a local-bus port for coupling to a local-bus; and
an RF front end coupled to said BB/MAC/RF processing unit via transmitting and receiving ports to transfer transmitting and receiving signal.

2. The module of claim 1, further comprising a first oscillator coupled to said BB/MAC/RF processing unit, wherein said first oscillator is capable to generate a first oscillation frequency.

3. The module of claim 2, wherein said first oscillation frequency is about 40 MHz.

4. The module of claim 1, further comprising a second oscillator coupled to said BB/MAC/RF processing unit, wherein said second oscillator is capable to generate a second oscillation frequency.

5. The module of claim 4, wherein said second oscillation frequency is about 32 KHz.

6. The module of claim 1, wherein said BB/MAC/RF processing unit includes a transmitting/receiving mode selection port that is coupled to said RF front end to allow said BB/MAC/RF processing unit to determine a processing mode.

7. The module of claim 1, further comprising a memory coupled to said BB/MAC/RF processing unit.

8. The module of claim 7, wherein said memory includes non-volatile memory.

9. The module of claim 1, wherein said RF front end module includes a first and a second antenna ports to couple to a first and a second antennas.

10. The module of claim 9, wherein said BB/MAC/RF processing unit includes an antenna diversity selection port that is coupled to said RF front end to allow said BB/MAC/RF processing unit to select an antenna diversity mode.

11. The module of claim 1, wherein said BB/MAC/RF processing unit includes a blue tooth port for coupling to a blue tooth module.

12. The module of claim 1, wherein said base band processor supports IEEE 802.11a/g data rates.

13. The module of claim 1, wherein said MAC supports IEEE 802.11 wireless MAC protocol.

14. The module of claim 1, wherein said MAC supports IEEE 802.11 wireless security.
